(19) United States
(12) Patent Application Publication
(10) Pub. No.: US 2011/0250403 A1
(43) Pub. Date: Oct. 13, 2011

(54) BONDING ON SILICON SUBSTRATE

(75) Inventors: John A. Higginson, Santa Clara, CA (US); Jeffrey Birkmeyer, San Jose, CA (US); Andreas Bibl, Los Altos, CA (US); Paul A. Hoisington, Hanover, NH (US)

(73) Assignee: FUJIFILM CORPORATION, Tokyo 107-005 (JP)

(21) Appl. No.: 13/063,355

(22) PCT Filed: Aug. 18, 2009
(86) PCT No.: PCT/US09/54165

§ 371 Date: Jun. 27, 2011

Related U.S. Application Data
(60) Provisional application No. 61/098,208, filed on Sep. 18, 2008.

(51) Int. Cl. B32B 3/30; B32B 37/10; B32B 37/12; B32B 9/04; B32B 18/00

(52) U.S. Cl. 428/172; 428/411.1; 428/697; 156/295

(57) ABSTRACT

A method and apparatus for bonding on a silicon substrate are disclosed. An apparatus includes a membrane having a lower membrane surface and an upper membrane surface, a transducer having a transducer surface substantially parallel to the upper membrane surface, and an adhesive connecting the membrane to the transducer surface. In some implementations, the lower membrane surface is substantially contiguous and the upper membrane surface protrudes therefrom. In some other implementations, the upper membrane surface is substantially contiguous and the lower membrane surface is recessed therein.

### BACKGROUND

The following disclosure relates to bonding on a substrate, such as a silicon die.

In some implementations of a fluid ejection device, fluid droplets are ejected from one or more nozzles onto a medium. The nozzles are fluidly connected to a fluid path that includes a fluid pumping chamber. The fluid pumping chamber is actuated by a transducer, and when actuated, the fluid pumping chamber causes ejection of a fluid droplet. The medium can be moved relative to the fluid ejection device. The ejection of a fluid droplet from a particular nozzle is timed with the movement of the medium to place a fluid droplet at a desired location on the substrate. In these fluid ejection devices, it is usually desirable to eject fluid droplets of uniform size and speed and in the same direction in order to provide uniform deposition of fluid droplets on the medium.

### SUMMARY

In one aspect, the systems, apparatus, and methods described herein include a membrane having a lower membrane surface and an upper membrane surface. A transducer can have a transducer surface that is substantially parallel to the upper membrane surface. An adhesive can connect the membrane to the transducer surface.

In another aspect, the systems, apparatus, and methods described herein include arranging a transducer surface of a transducer proximate a membrane. The membrane can have an upper membrane surface and a lower membrane surface. The transducer surface can be facing the upper membrane surface and can be substantially parallel thereto. Adhesive can be applied to the transducer surface or the upper membrane surface or both. The transducer can be pressed against the membrane surface. At least some of the adhesive can be allowed to flow toward or along the lower membrane surface.

Implementations can include one or more of the following features. In some implementations, the lower membrane surface can be generally contiguous and the upper membrane surface can protrude from the lower membrane surface, such as by between about 2.0 microns and about 5.0 microns. The apparatus can include multiple upper membrane surfaces. The multiple upper membrane surfaces can be formed at about equal height with respect to one another, can be substantially circular, and can be located near a critical bond area. In some other implementations, the upper membrane surface can be generally contiguous and the lower membrane surface can be recessed into the upper membrane surface, such as by between about 2.0 microns and about 5.0 microns. The apparatus can include multiple lower membrane surfaces recessed into the upper membrane surface. The multiple lower membrane surfaces can be formed at about equal depth with respect to one another, can be substantially circular, and can be located near a critical bond area. The adhesive can include benzocyclobutene. The transducer can include a piezoelectric material, such as lead zirconium titanate.

In some embodiments, one or more of the following advantages may be provided. Flow of adhesive into recesses or grooves can reduce the thickness of adhesive between the transducer and the membrane. Reducing the thickness of adhesive can reduce the energy required to actuate a transducer to change the volume of a fluid pumping chamber so as to cause fluid droplet ejection. As a further advantage of recesses, providing space for adhesive to flow can mitigate or prevent a build-up of adhesive, which could press the membrane into the pumping chamber and thereby alter the effectiveness of the transducer when actuated. Because such build-up can be non-uniform across multiple actuators and fluid pumping chambers, the recesses can improve uniformity of fluid droplet ejection size and speed, as well as the accuracy of placement of fluid droplets on a medium.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a cross-sectional view of an apparatus for fluid droplet ejection.

FIG. 2 is a flow diagram of a process of bonding a layer.

FIGS. 3-7 are cross-sectional views of stages of forming an apparatus for fluid droplet ejection.

FIG. 8A is a cross-sectional view of a portion of an apparatus for fluid droplet ejection.

FIG. 8B is a cross-sectional view along line 8-8 in FIG. 8A.

FIG. 9 is a cross-sectional view of a portion of an apparatus for fluid droplet ejection.

FIG. 10 is a plan view of a portion of the apparatus of FIG. 9.

FIG. 11 is a flow diagram of a process of bonding a layer.

FIGS. 12-17 are cross-sectional views of stages of forming an apparatus for fluid droplet ejection.

Like reference symbols in the various drawings indicate like elements.

### DETAILED DESCRIPTION

An apparatus for fluid droplet ejection can have a fluid ejection module, e.g., a rectangular plate-shaped printhead module, which can be a die fabricated using semiconductor processing techniques. The fluid ejector can also include a housing to support the printhead module, along with other components such as a flex circuit to receive data from an external processor and provide drive signals to the printhead module.

The printhead module includes a substrate in which a plurality of fluid flow paths are formed. The printhead module also includes a plurality of actuators, e.g., transducers, to cause fluid to be selectively ejected from the flow paths. Thus, each flow path with its associated actuator provides an individually controllable MEMS fluid ejector unit.

The substrate can include a flow-path body, a nozzle layer, and a membrane layer. The flow-path body, nozzle layer, and membrane layer can each be silicon, e.g., single crystal silicon. The fluid flow path can include a fluid inlet, an ascender, a pumping chamber adjacent the membrane layer, and a descender that terminates in a nozzle formed through the nozzle layer. Activation of the actuator causes the membrane to deflect into the pumping chamber, forcing fluid out of the nozzle.

The membrane can have recesses formed therein. An adhesive can bond or connect a transducer to the membrane, and the adhesive can at least partially occupy the recesses. The recesses can be arranged to define protrusions, such as posts, on the membrane. Alternatively, the recesses can be formed as grooves in the membrane.

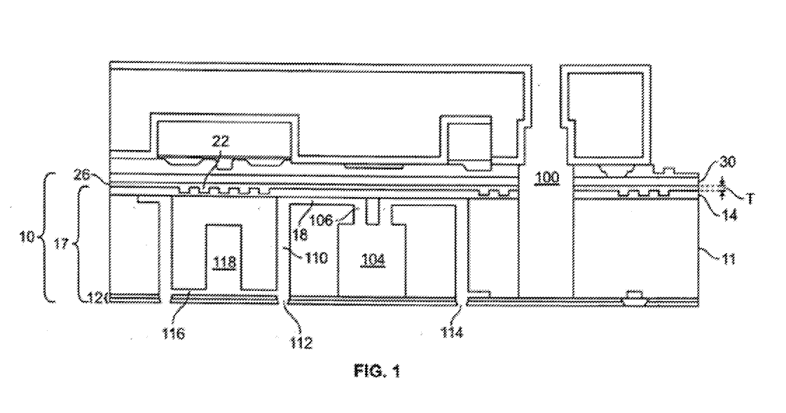

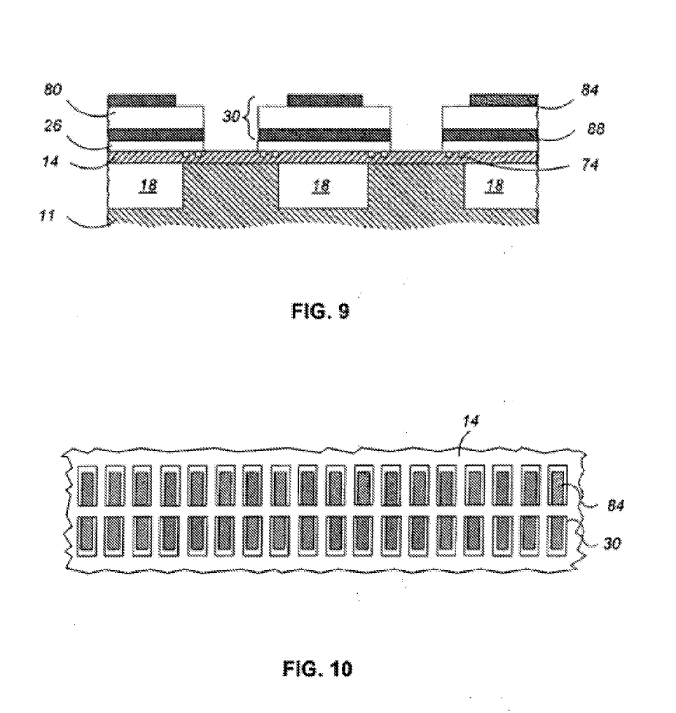

FIG. 1 is a cross-sectional view of a portion of a fluid droplet ejection apparatus. An inlet 100 fluidically connects a fluid supply (not shown) to a die 10 that includes a substrate 17 and a transducer 30. The substrate 17 includes a flow-path body 11. The inlet 100 is fluidly connected to an inlet passage 104 formed in the flow-path body 11 through a passage (not shown). The inlet passage 104 is fluidically connected to a pumping chamber 18, such as through an ascender 106. The pumping chamber 18 is fluidically connected to a descender 110, at the end of which is a nozzle 112. The nozzle 112 can be defined by a nozzle layer, such as a nozzle plate 12, that is attached to the flow-path body 11. The nozzle 112 includes an outlet 114 defined by an outer surface of the nozzle plate 12. In some implementations, a recirculation passage 116 can be provided to fluidically connect the descender 110 to a recirculation channel 118. A membrane 14 is formed on top of the flow-path body 11 in close proximity to and covering the pumping chamber 18, e.g. a lower surface of the membrane 14 can define an upper boundary of the pumping chamber 18. A transducer 30 is disposed on top of the membrane 14, and a layer of adhesive 26 with a thickness T is between the transducer 30 and the membrane 14 to bond the two to one another. In some implementations, each pumping chamber 18 has a corresponding electrically isolated transducer 30 that can be actuated independently. The transducer 30 includes electrodes 84, 88 (FIG. 9) to allow for actuation of the transducer 30 by a circuit (not shown).

A top surface of the membrane 14, i.e., the surface closer to the transducer, includes recesses 22 that are at least partially filled with the adhesive 26, as discussed below. The recesses 22 extend partly, but not entirely, through the membrane 14. The recesses 22 can be located only in regions of the membrane that are not directly over the pumping chambers 18. However, in some implementations some recesses 22 can be located over the pumping chambers 18.

The membrane 14 can be formed of silicon (e.g., single crystalline silicon), some other semiconductor material, oxide, glass, aluminum nitride, silicon carbide, other ceramics or metals, silicon-on-insulator, or any depth-profilable layer. Depth profiling methods can include etching, sand blasting, machining, electrical-discharge machining (EDM), micro-molding, or spin-on of particles. For example, the membrane 14 can be composed of an inert material and have compliance such that actuation of the transducer 30 causes flexure of the membrane 14 sufficient to pressurize fluid in the pumping chamber 18 to eject fluid drops from the nozzle 112. U.S. Patent Publication No. 2005/0099467, published May 12, 2005, the entire contents of which is hereby incorporated by reference, describes examples of a printhead module and fabrication techniques. In some implementations, the membrane 14 can be formed unitary with the flow-path body 11.

In operation, fluid flows through the inlet channel 100 into the flow-path body 11 and through the inlet passage 104. Fluid flows up the ascender 106 and into the pumping chamber 18. When a transducer 30 above a pumping chamber 18 is actuated, the transducer 30 deflects the membrane 14 into the pumping chamber 18. The resulting change in volume of the pumping chamber 18 forces fluid out of the pumping chamber 18 and into the descender 110. Fluid then passes through the nozzle 112 and out of the outlet 114, provided that the transducer 30 has applied sufficient pressure to force a droplet of fluid through the nozzle 112. That is, the transducer 30 pressurizes the fluid pumping chamber 18, and a resulting pressure pulse, which can be referred to as a firing pulse, effects ejection of a droplet of fluid through the nozzle 112. The droplet of fluid can then be deposited on a medium.

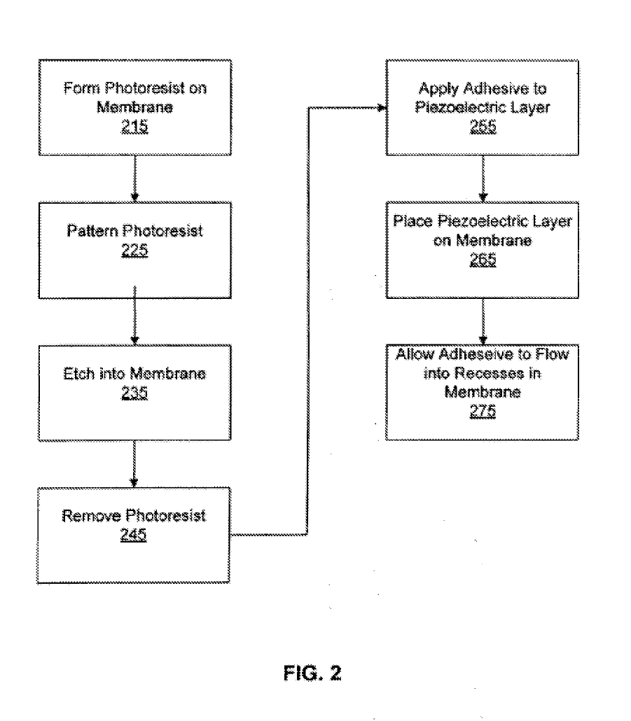

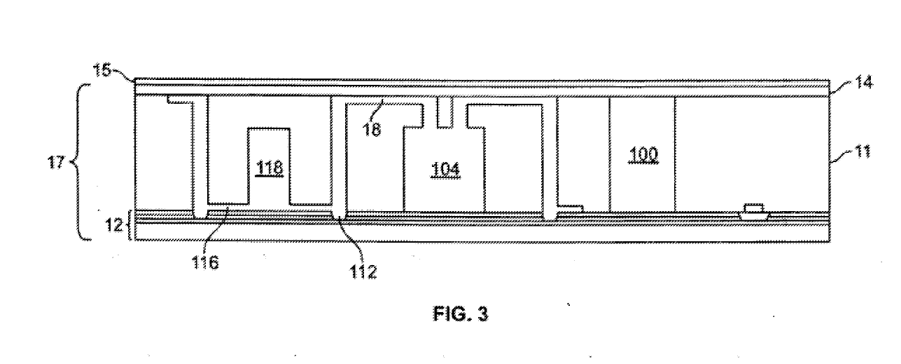

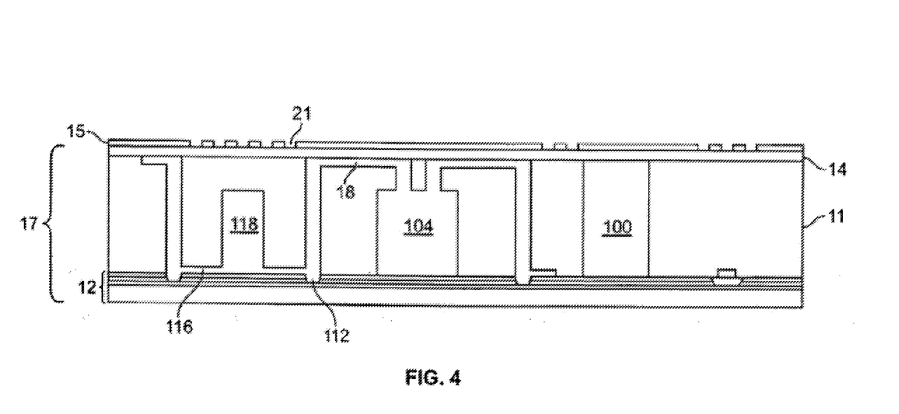

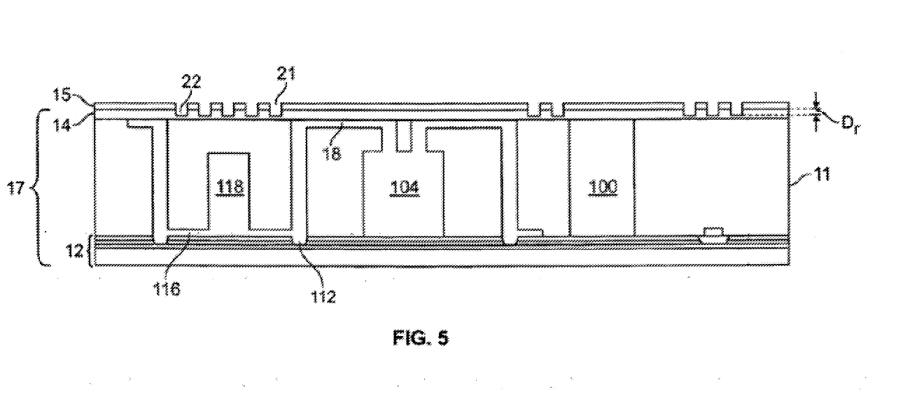

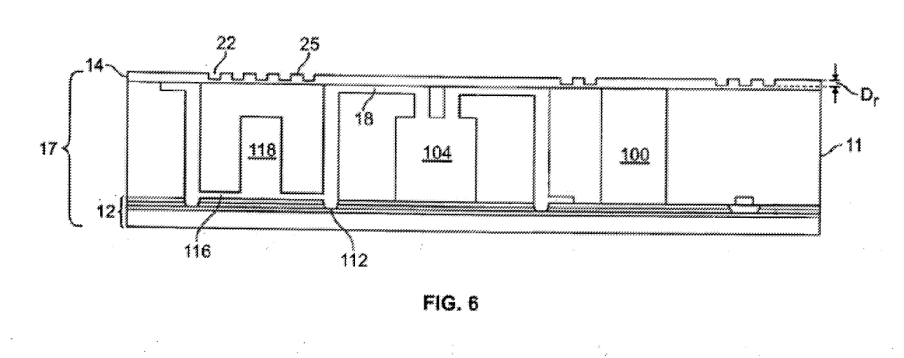

FIG. 2 is a flow chart of a process for bonding the transducer 30 to the membrane 14 on a flow-path body 11. FIGS. 3-9 are cross-sectional diagrams of steps in the fabrication of an apparatus for fluid droplet ejection. As shown in FIG. 3, a photoresist layer 15 is formed on top of the membrane 14 (step 215). In some implementations, the nozzle plate 12 has multiple layers, some of which can be used for holding the apparatus during fabrication and can be removed during later fabrication steps. As shown in FIG. 4, the photoresist layer 15 is patterned using conventional photolithography techniques so that portions of the photoresist layer 15 are removed, and apertures 21 are thereby formed in the photoresist layer 15 (step 225). Referring to FIG. 5, the membrane 14 is etched through the apertures 21 in the photoresist layer 15 to form recesses 22 in the membrane 14 (step 235). As shown in FIG. 6, the photoresist layer 15 is then removed (step 245).

In the implementation shown, the recesses 22 do not extend entirely through the membrane 14. The depth of etching into the membrane 14 can be controlled, for example, by etching for a predetermined amount of time, stopping the etching process when a desired recess depth Dᵣ of the recesses 22 has been achieved as detected by an in-situ monitoring system, or by including an etch-stop layer in the membrane 14 at depth Dᵣ. In some implementations, the recess depth Dᵣ is between about 0.5 microns and about 10 microns, such as between about 2.0 microns and about 5.0 microns, and each of the recesses 22 are of substantially equal recess depth Dᵣ. The area between the recesses 22 defines posts 25, which can also be referred to as protrusions. The posts 25 have a height equal to the recess depth Dᵣ. In alternative implementations, the recesses 22 can extend entirely through the membrane 14 so long as remaining membrane material adjacent the recesses 22 is adequately supported, such as by the flow-path body 11.

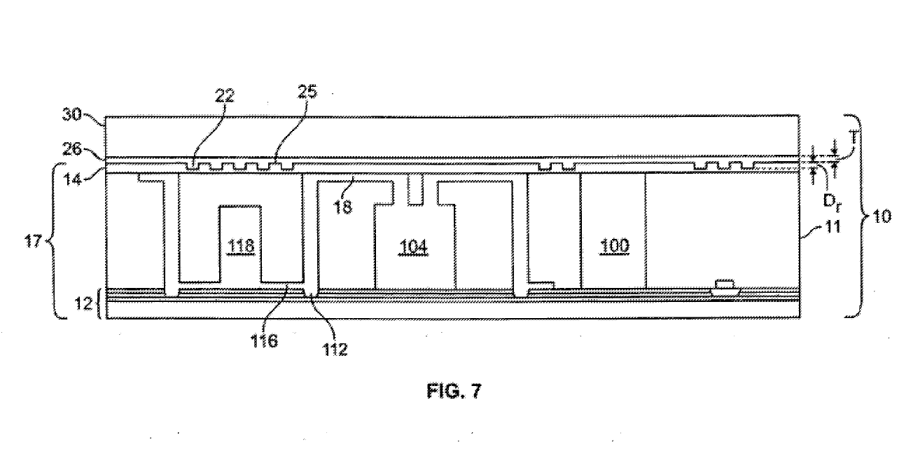

Referring to FIG. 7, adhesive 26 is applied to, or formed on, a surface of the transducer 30 facing the membrane 14 (step 255), and the transducer 30 with adhesive 26 is placed on the membrane 14 (step 265). Alternatively, adhesive 26 is applied to the membrane 14 instead of, or in addition to, adhesive 26 being applied to the transducer 30. Pressure can be applied to press the substrate 17 and the transducer 30 toward each other, and adhesive 26 is allowed to at least partially flow into the recesses 22 (step 275).

The membrane 14 can have a thickness of between about 1.0 micron and about 150 microns, such as between about 8.0 microns and about 20 microns. This thickness can be selected based in part on a desired recess depth Dᵣ. The depth selected for the recesses 22, and thus the height of the posts 25, can depend on the viscosity of the adhesive 26 during the curing state and the thickness of the adhesive 26 applied to either the membrane 14 or the transducer 30. Temperature can affect the viscosity of the adhesive during the curing cycle, such as by making the adhesive 26 more viscous. A highly viscous adhesive 26 may flow slowly and need more space to flow sufficiently before curing. For example, relatively tall posts 25 may be needed to allow a highly viscous adhesive 26 to flow. Similarly, the greater the thickness of adhesive 26 between the membrane 14 and the transducer 30, the more space may be needed to hold excess adhesive 26. In some implementations, when a layer of adhesive 26 applied to the transducer 30 has a thickness of about 1.0 micron, the height of the posts 25 is between about 2.0 microns and about 5.0 microns. Alternatively, rather than defining posts 25, the recesses 22 can define grooves, as described in U.S. Patent Application No. 61/098,187 filed concurrently herewith, the entire contents of which is incorporated herein by reference.

FIG. 7 shows the transducer 30 and adhesive 26 on top of the membrane 14. The adhesive 26 is between the transducer 30 and the membrane 14 and can partially or entirely fill the recesses 22. The transducer 30 and the membrane 14 are not in direct contact because a layer of adhesive 26 is between them. As the thickness T of the layer of adhesive 26 increases, more energy (e.g., greater voltage) must be applied to the transducer 30 to cause sufficient deformation to effect fluid droplet ejection. Reducing the thickness of the layer of adhesive 26 is therefore desirable to minimize the energy requirements of the transducer 30.

In some implementations, the adhesive 26 must be present in a minimum thickness because of the material properties of the adhesive 26 or other limitations such as the process for applying the adhesive. For example, in the absence of the recesses 22, with some types of adhesives, the minimum thickness of the adhesive 26 can be between about 1000 nanometers and about 1200 nanometers. The recesses 22 can reduce the minimum achievable thickness of adhesive 26 by allowing some adhesive to flow into the recesses 22 when the transducer 30 and adhesive 26 are pressed toward the membrane 14. In contrast, where recesses 22 are present, the minimum achievable thickness of the adhesive 26 can be about 200 nanometers or less, such as about 100 nanometers or less.

To attempt to achieve a minimum thickness of the adhesive 26, the transducer 30 and the membrane 14 can be pressed together to squeeze out excess adhesive 26. A flow resistance of the adhesive 26 increases linearly with an increase in a distance that the adhesive 26 travels before exiting from between the transducer 30 and the membrane 14. For example, without the recesses 22, adhesive 26 near a center of the transducer 30 and the membrane 14 travels about 75 millimeters before being squeezed out. As a contrasting example, where the membrane 14 has recesses 22 formed therein, adhesive 26 near the center only travels about 150 microns to flow into the recesses 22. Since the flow resistance is proportional to the distance traveled, adhesive 26 flowing into the recesses 22 has a flow resistance that is about 500 times less than without the recesses 22. Thus, more excess adhesive 26 can be squeezed out before curing, which can result in a relatively thinner layer of adhesive 26. For example, if a 1.0 micron layer of adhesive 26 is applied between the two parts, the minimum thickness without recesses 22 might be between about 1000-1200 nanometers. With recesses 22, by contrast, a minimum thickness of adhesive 26 may be about 200 nanometers or less. The flow resistance of the adhesive between the transducer 30 and membrane 14 can be described by the formula R=kμL/t³, where R is flow resistance, k is a constant, μ is a viscosity of the fluid, L is a length, and t is a thickness of the adhesive 26.

As noted, the adhesive 26 can be applied to the transducer 30 before bonding. In other implementations, the adhesive 26 is applied to the membrane 14 instead of, or in addition to, adhesive 26 being applied to the transducer 30. The amount of adhesive 26 applied in the recesses 22 can be minimized to maximize the percentage of applied adhesive 26 that flows into the recesses 22. The adhesive 26 can be an organic material, such as benzocyclobutene (BCB), or other suitable material.

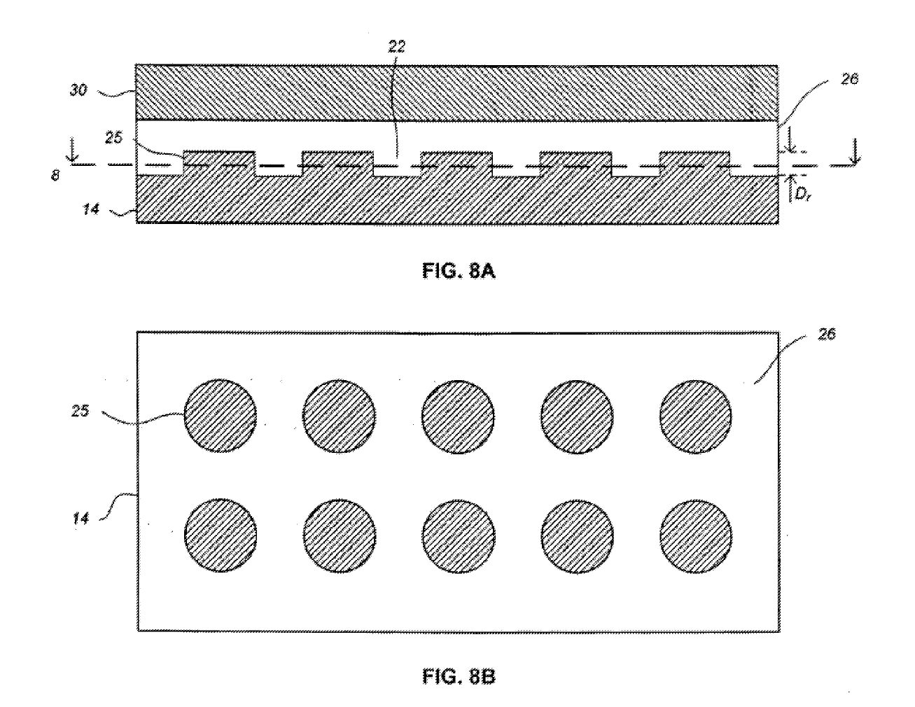

FIGS. 8A and 8B show an implementation of the membrane 14, adhesive 26, and transducer 30. The distance between the membrane 14 and the transducer 30 has been exaggerated for illustrative purposes. In this implementation, the posts 25 are substantially circular and adhesive 26 is positioned between the posts 25 and between the membrane 14 and the transducer 30. Alternatively, the posts 25 can be square, rectangular, oval, some other closed shaped, or some other suitable shape. In addition, in this implementation, the recess 22 surrounds multiple posts 25, e.g., the recess is a generally continuous single area on the substrate.

FIG. 9 shows a cross-section of an implementation of transducers 30 on the membrane 14 above pumping chambers 18. Multiple pumping chambers 18 are shown, and in this implementation, the membrane 14 includes recesses 22 in portions of the membrane 14 near, but not directly over, the pumping chambers 18. The transducer 30 includes a top electrode 84, a piezoelectric layer 80, and a bottom electrode 88. The top electrode 84 and the bottom electrode 88 are arranged on the top and bottom surface, respectively, of the piezoelectric layer 80. The adhesive 26 bonds the transducer 80 to the membrane 14. A circuit (not shown) can be electrically connected to the top electrode 84 and to the bottom electrode 88. The circuit can apply a voltage between the electrodes 84, 88. The applied voltage can actuate the transducer 30, causing the piezoelectric material to deform. This deformation can deflect the membrane 14 into the pumping chamber 18, thereby forcing fluid out of the pumping chamber 18.

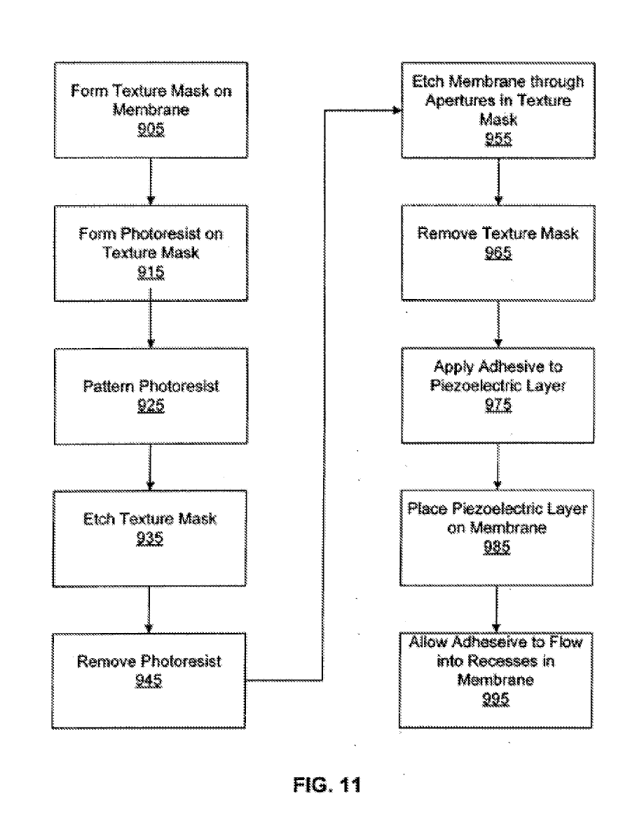

FIG. 10 is a plan diagram of the implementation shown in FIG. 9, and two rows of transducers 30 are shown. These two rows of transducers 30 correspond to two rows of pumping chambers 18, which can correspond to two rows of nozzles 112 beneath the pumping chamber 18.

In some implementations, the recesses 22 can be arranged in a continuous or interconnected manner to define protrusions on the surface of the membrane 14, such as circular protrusions. In other implementations, the recesses 22 can be disconnected, and can themselves be circular. Alternatively, the recesses 22 can form grooves along a length of the membrane 14. In some implementations, the recesses 22 can be formed in portions of the membrane 14 above a pumping chamber 18. In other implementations, the recesses 22 can be formed in portions of the membrane 14 not above a pumping chamber 18. In some implementations, the recesses 22 can be formed near critical bond areas. Critical bond areas can include portions of the membrane 14 near the edges of a pumping chamber 18.

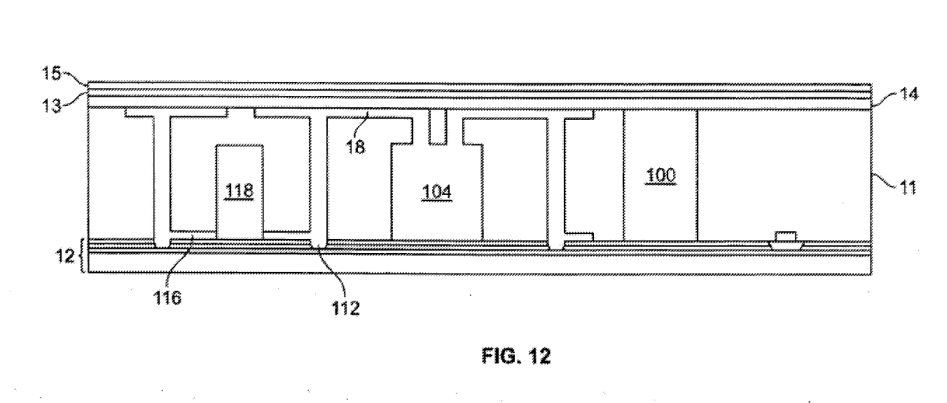

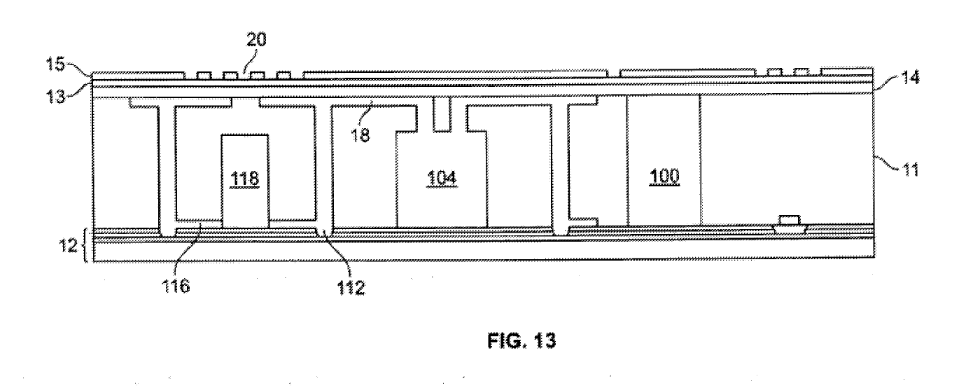

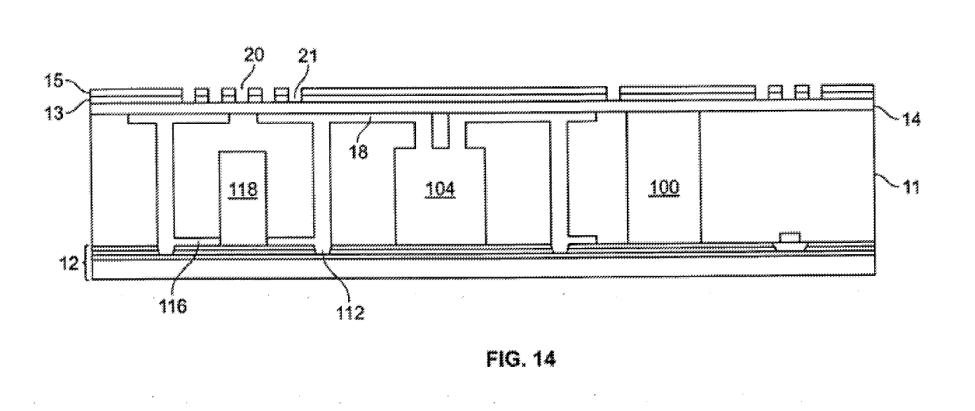

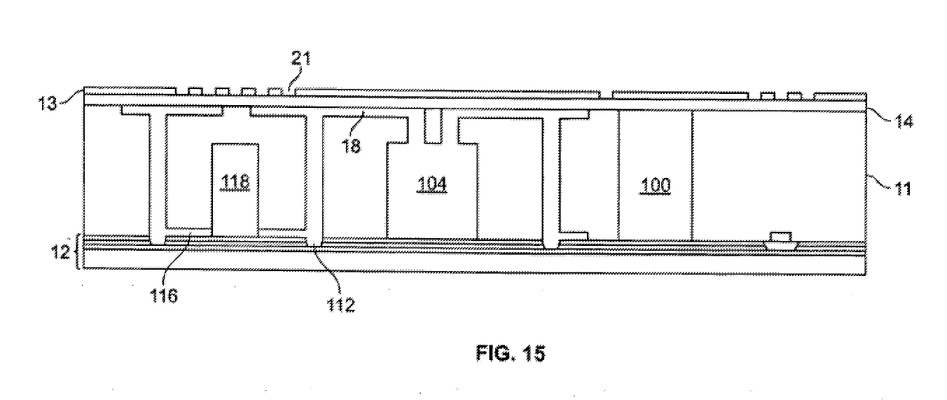

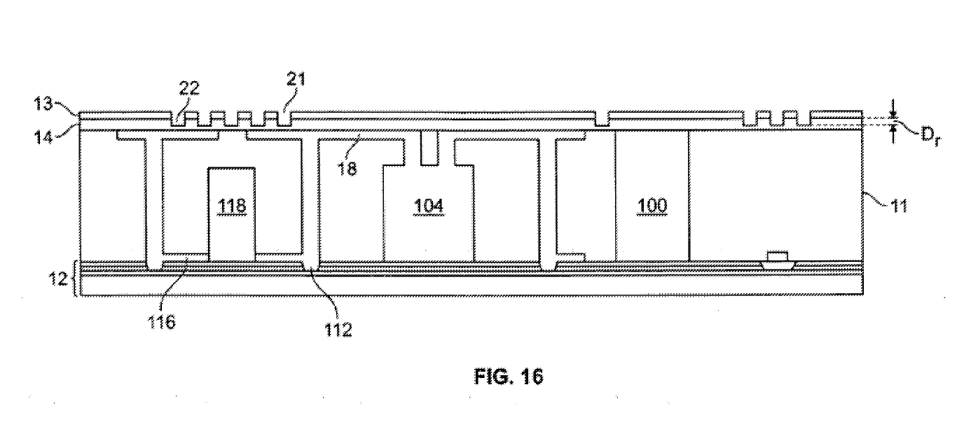

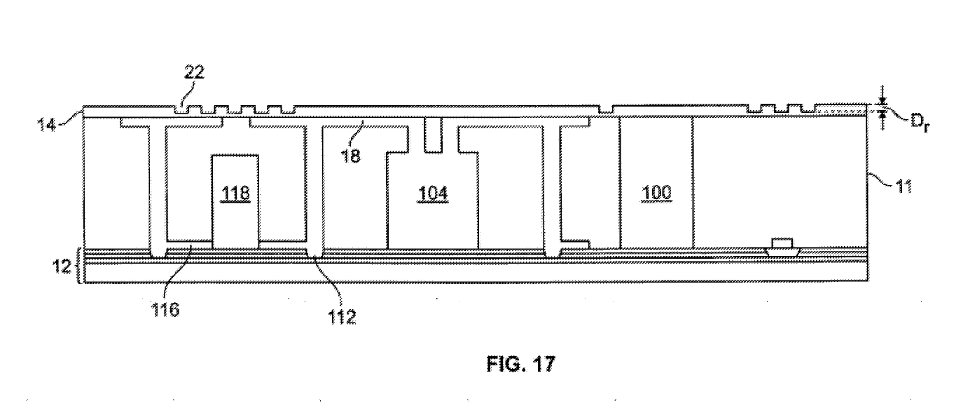

FIG. 11 is a flow chart showing an alternative method of forming the recesses 22 in the membrane 14. FIGS. 12-17 are cross-sectional diagrams of steps in the fabrication of an apparatus for fluid droplet ejection. As shown in FIG. 12, a texture mask 13 is formed on top of the membrane 14 (step 905). The texture mask 13 can be made from an oxide, such as silicon oxide. Use of a texture mask 13 can be desirable where, for example, the texture mask 13 has a higher selectivity than a photoresist. That is, a relatively smaller thickness of texture mask 13 can be used to etch the membrane 14 to a relatively larger depth. A photoresist layer 15 is formed on top of the texture mask 13 (step 915). Referring to FIG. 13, the photoresist layer 15 is patterned using conventional photolithography techniques so that portions of the photoresist layer 15 are removed, and apertures 20 are thereby formed in the photoresist layer 15 (step 925). Referring to FIG. 14, the texture mask 13 is etched through the apertures 20 in the photoresist layer 15 to form apertures 21′ in the texture mask 13 (step 935). Referring to FIG. 15, the photoresist layer 15 is then removed (step 945). Referring to FIG. 16, the membrane 14 is then etched through the apertures 21′ in the texture mask 13 to form membrane recesses 22 (step 955). In some implementations, the membrane recesses 22 do not extend entirely through the membrane 14, as described above. Referring to FIG. 17, the texture mask 13 is then removed, such as by grinding, by bathing in hydrofluoric acid, or some other suitable mechanical or chemical mechanism (step 965). Adhesive 26 is applied to, or formed on, a surface of the transducer 30 facing the membrane 14 (step 975), and the transducer 30 with adhesive 26 is placed on the membrane 14 (step 985), as shown in FIG. 7. Alternatively, adhesive 26 is applied to the membrane 14 instead of, or in addition to, adhesive 26 being applied to the transducer 30. Pressure is applied, and adhesive 26 is allowed to at least partially flow into the membrane recesses 22 (step 995).

The above-described implementations can provide none, some, or all of the following advantages. Flow of the adhesive into recesses or grooves can minimize the thickness of the adhesive between the transducer and the membrane. Reducing the thickness of adhesive can reduce the energy required to actuate a transducer and change the volume of a fluid pumping chamber so as to cause fluid droplet ejection. Further, where the thickness of applied adhesive is non-uniform, providing space for adhesive to flow can mitigate or prevent a build-up of adhesive, which might otherwise press the membrane into the pumping chamber and thereby influence the effectiveness of the transducer when actuated. Particularly where multiple pumping chambers and nozzles are used, varying degrees of deflection of the membrane into the pumping chambers can result in varying degrees of effectiveness among the multiple pumping chambers. Variations in the effectiveness across multiple pumping chambers can cause variation of fluid droplet ejection size or speed among the multiple nozzles, which may cause incorrect fluid droplet size or placement on a medium. By mitigating or preventing deflection of the membrane by adhesive, the recesses described above can improve uniformity of fluid droplet ejection size or speed. Uniformity among actuators on a die is thereby improved, which decreases the likelihood of incorrect fluid droplet placement.

The use of terminology such as “front,” “back,” “top,” and “bottom” throughout the specification and claims is for illustrative purposes only, to distinguish between various components of the fluid droplet ejection apparatus and other elements described herein. The use of “front,” “back,” “top,” and “bottom” does not imply a particular orientation of the fluid droplet ejection apparatus, the substrate, the die, or any other component described herein.

A number of embodiments of the invention have been described. Nevertheless, it will be understood that various modifications may be made without departing from the spirit and scope of the invention. For example, recesses in the membrane could be any shape or profile that provides space for adhesive to flow or reside. Accordingly, other embodiments are within the scope of the following claims.

What is claimed is:

1. An apparatus comprising:
a membrane having a lower membrane surface and an upper membrane surface;
a transducer having a transducer surface substantially parallel to the upper membrane surface; and
an adhesive connecting the membrane to the transducer surface.

2. The apparatus of claim 1, wherein the lower membrane surface is generally contiguous and the upper membrane surface protrudes from the lower membrane surface.

3. The apparatus of claim 2, wherein the upper membrane surface protrudes from the lower membrane surface by between about 2.0 microns and about 5.0 microns.

4. The apparatus of claim 2, further comprising a plurality of upper membrane surfaces.

5. The apparatus of claim 4, wherein the upper membrane surfaces are formed at about equal height with respect to one another.

6. The apparatus of claim 2, wherein the upper membrane surface is substantially circular.

7. The apparatus of claim 2, wherein the upper membrane surface is located near a critical bond area.

8. The apparatus of claim 1, wherein the upper membrane surface is generally contiguous and the lower membrane surface is recessed into the upper membrane surface.

9. The apparatus of claim 8, wherein the lower membrane surface is recessed into the upper membrane surface by between about 2.0 microns and about 5.0 microns.

10. The apparatus of claim 8, further comprising a plurality of lower membrane surfaces recessed into the upper membrane surface.

11. The apparatus of claim 10, wherein the lower membrane surfaces are formed at about equal depth with respect to one another.

12. The apparatus of claim 8, wherein the lower membrane surface is substantially circular.

13. The apparatus of claim 8, wherein the lower membrane surface is located near a critical bond area.

14. The apparatus of claim 1, wherein the adhesive comprises benzocyclobutene.

15. The apparatus of claim 1, wherein the transducer comprises a piezoelectric material.

16. The apparatus of claim 15, wherein the piezoelectric material comprises lead zirconium titanate.

17. A method comprising:
arranging a transducer surface of a transducer proximate a membrane having an upper membrane surface and a lower membrane surface, the transducer surface facing and being substantially parallel to the upper membrane surface;
applying an adhesive to the transducer surface or the upper membrane surface or both;
pressing the transducer surface against the membrane surface; and
allowing at least some of the adhesive to flow toward or along the lower membrane surface.

18. The method of claim 17, wherein the transducer comprises a piezoelectric material.

19. The method of claim 18, wherein the piezoelectric material comprises lead zirconium titanate.

20. The method of claim 17, wherein the adhesive comprises benzocyclobutene.
